(19) United States
(12) Patent Application Publication
(10) Pub. No.: US 2024/0067502 A1
(43) Pub. Date: Feb. 29, 2024

(54) LIFT ASSEMBLY AND ASSEMBLING/DISMANTLING AND DOCKING METHOD

(71) Applicant: XL INDUSTRIES, PUCEUL (FR)

(72) Inventors: Gabriel NARDELLI, CASSON (FR); Alexandre NARDELLI, GUJAN MESTRAS (FR)

(21) Appl. No.: 17/998,542

(22) PCT Filed: May 12, 2021
(86) PCT No.: PCT/FR2021/050840

§ 371 Date: Nov. 11, 2022

(30) Foreign Application Priority Data
May 14, 2020 (FR) FR2004757

(51) Int. Cl. B66B 9/02; B66B 5/04; B66B 19/00

(52) U.S. Cl. CPC B66B 9/022; B66B 5/04; B66B 19/002

(57) ABSTRACT

An elevator assembly with a rack-and-pinion drive including a tower and an elevator. The elevator assembly is designed to allow the autonomous inverse assembly of the tower on a shaft and/or a gallery during excavation processes. The elevator assembly descends along a suspended tower as far as a bottom end of the tower to convey mast sections to be assembled under the tower. The mast sections to be assembled are positioned for fishplating thereof, one by one, by means of a movable deck of the elevator assembly. A inverse assembly method, a docking method, and a method for dismantling the elevator assembly are also provided.

### CROSS REFERENCE TO RELATED APPLICATIONS

This application is a National Stage of International Application No. PCT/FR2021/050840, having an International Filing Date of 12 May 2021, which designated the United States of America, and which claims priority from and the benefit of French Patent Application No. 2004757 filed on 14 May 2020, the disclosures of which are incorporated herein by reference in their entireties.

### BACKGROUND

### Field

The present disclosure relates to the field of elevators, and in particular building-site elevators intended for excavation activities.

In particular, the disclosure relates to an elevator assembly that can be assembled autonomously by inverse assembly, i.e. by a gradual assembly of a mast from top to bottom of the works.

The disclosure also relates to the docking and dismantling of said elevator.

### Brief Description of Related Developments

In construction sites, to implement digging activities, for example access shafts and/or the digging of galleries, use is generally made of elevator or lift nacelles in order to lower or raise operators responsible for the excavation or the implementation of the works. The use of an elevator is desirable but implementation thereof is complex in a site digging for example a gallery or a shaft. This is because the bottom of the latter is not stable since it is in the process of being dug out and its height changes with the advancement of the digging level. It is therefore not possible to bear on the ground to install an elevator.

One known solution consists of suspending the elevator at the top part of the works and gradually assembling the tower downwards, this assembly, referred to as “inverse”, is implemented by incrementing mast sections under a first tower section already in place. This solution is complex and is implemented using external means. For example, assembling a suspended elevator according to the prior art involves:
the use of a crane, or another lifting means for conveying, one after the other, the mast sections below the level of the tower already in place;
the use of a winch (or other handling lifting means) placed in the tower already in place for transferring the mast section to be installed from the crane to the winch. The mast section is hoisted/lifted with the winch, vertically in line with the tower already in place, until it comes into contact;
the use of an elevator nacelle (or other means for access at a height), for accessing and implementing the joining of the mast section and the tower; for accessing and positioning the stability anchorings; and for accessing and positioning a bottom stop (preventing the cabin emerging from the tower);
the need for several operators: crane operator, elevator operator in the storage zone, nacelle driver, fitter.

The patent FR 2964960B1 gives an example of a suspended elevator the guidance mast of which is assembled gradually by means of a crane as described above. This solution allows the use and assembly of a suspended operator in a digging site. However, it is wished to proceed with the assembly of a suspended elevator that is autonomous and easier to implement. It is also desired for said elevator to be able to dock in a secure manner at the bottom of the dig during and after the digging works, as well as for it to be able to be dismantled quickly and simply.

### SUMMARY

The present disclosure proposes an elevator assembly with pinion/rack drive allowing inverse assembly of a tower, i.e. from top to bottom. The elevator assembly makes it possible to extend the length of a tower, by the gradual assembly of mast sections conveyed and positioned for fishplating thereof by means of said elevator.

More particularly, the disclosure proposes an elevator assembly with rack and pinion drive for excavation activities, said assembly including a tower provided with a rack and being assembled from a plurality of mast sections, a cabin including an electric cubicle and a center for controlling said cabin, characterized in that said cabin includes:
a top part including a drive unit wherein a pinion drive system cooperating with said rack, elements for guidance with the tower and a system for secure stoppage of the cabin are installed;
a bottom part, secured to the top part and including a cage provided with a movable deck, said deck having an extended position for positioning a mast section to be assembled vertically in line with a bottom end of said tower when it is already in place and suspended from a structure, and a position retracted in a floor of the cage. Preferably, said cage also includes at least one position sensor and a means for locking said deck.

The design of the elevator is highly advantageous in that the cabin cooperates with the tower only by means of the drive unit disposed on the top part of the cabin. The cage is therefore suspended from the tower by means of said drive unit and does not require guidance with the tower. This cabin architecture allows the positioning of the cabin cage below the tower when the drive unit is stopped at a lower part of the tower. It is thus possible to convey and position the mast sections easily by means of the cabin.

Advantageously, the secure stop system allows the positioning of the cabin below the tower in complete safety, said safety stop system including:
a parachute device able to brake and stop the pinion drive system in the case of overspeed;
a device for detecting absence of lower and/or upper mast configured for transmitting a stop signal for the cabin when it detects a bottom and/or top end of the tower;
a device for automatic top stoppage of the drive unit including at least one position sensor for the drive unit activated by a top stop cam secured at a predetermined safety distance from a top end of the tower;
an automatic device for bottom stoppage of the drive unit including at least one bottom position sensor for the drive unit activated by a bottom stop cam secured to a chassis of the drive unit;
an anti-fall device including a locking member configured for engaging with the rack when said device reaches the bottom end of the rack;
damper stops cooperating where necessary with a bottom stop installed on a bottom part of the tower.

In order to start the inverse assembly of the tower, it is first necessary to install, at the top part of the structure, a first subassembly including the cabin and a first part of the tower. For this purpose, the elevator assembly includes a suspension ramp corresponding to this first tower part, said suspension ramp being preassembled from a plurality of mast sections and including:
a head mast section including a lifting beam on a top end and not being provided with a rack;
a suspension mast section including a connecting part intended to cooperate with an anchoring part secured at the top part of the excavation for suspending said suspension ramp, and being provided with a rack section;
standard mast sections including a rack section.

In one embodiment, the elevator assembly is also provided with an anti-collision system communicating with the electric cubicle and the control center of the cabin, said anti-collision system including:
an object detector configured for transmitting an emergency stop signal when an object is detected in a docking zone of the cabin;
a distance sensor configured for transmitting a travel speed controlling signal according to a distance detected between the cabin and the ground; and
a plunger provided with at least one position switch for demanding stopping of the travel, said plunger extending from a bottom part of the cabin towards the ground and having a height Y defining a minimum stop distance between the floor of said cabin and the ground of the works, and for which the position switch is activated when a foot of the plunger contacts the ground.

In one embodiment the object detector includes a detection beam on a horizontal plane, said beam being positioned at a predefined distance X1 from a bottom face of the cage, and corresponding substantially to a distance X2 travelled by the cabin to obtain its total stoppage following a stop command triggered when the cabin moves at a programmed docking speed.

In one embodiment, the elevator assembly includes a load transfer system enabling the suspended tower to bear on the ground, said system including at least one foot adjustable for height assembled with the bottom end of the tower, and for which an increase in height of said foot makes it possible to put said foot in contact with the ground, and to transfer a weight of the elevator assembly from a point of suspension of the tower to the ground.

The disclosure also relates to the methods for using the elevator assembly, in particular for the inverse assembly of the tower, the docking of the elevator, and dismantling thereof.

More particularly, the disclosure proposes a method for the inverse assembly of a tower by means of the elevator assembly of the disclosure, said method including a step of inverse assembly of the tower by gradual fishplating of a plurality of standard mast sections conveyed by means of said elevator, said step including the following substeps, repeated until a required length of tower is obtained:
lowering a cabin of the elevator along a part of the tower previously installed and as far as a bottom end of said tower; said cabin having been loaded with n standard mast sections;
stoppage of a floor of the cabin at a level below the tower;
positioning a standard mast section on a movable deck of a cabin of the elevator, an extended position of said deck making it possible to place said mast section vertically in line with the last mast section of the suspended tower;
raising the cabin until the mast sections are put in contact and fishplating said section;
stabilizing the suspended tower by attaching secondary anchoring parts every n standard mast sections assembled.

In one embodiment, the assembly method includes a prior step wherein, at the top part of the structure, a first subassembly is installed including said cabin mounted on a suspension ramp, in which step the suspension ramp is slung from a beam for lifting said ramp, and suspended by a part for connecting said ramp to a first anchoring part secured to said top part of the structure.

The disclosure also proposes a method for optimized docking of the elevator by means of an anti-collision system, said system including a plunger provided with a position switch, an object detector and a distance sensor, said method including the following steps:
lowering the cabin at a first predefined travel speed and concomitantly measuring the distance between the cabin of the elevator and the ground by means of said distance sensor. For example at a first speed of 36 m/min;
stopping the travel of the cabin when a minimum distance threshold between the cabin and the ground is signaled by the distance sensor, and preferably activating an audible warning. For example a threshold of 4 m;
lowering the cabin at a second reduced speed during which the object detector monitors a zone for docking of the elevator on the ground and the surroundings thereof. For example a second speed of 10 m/min;
stopping the cabin when an obstacle is detected by the object detector in said docking zone monitored or when the plunger touches the ground.

This method is highly advantageous in that it allows a safe docking of the elevator when the excavation works are under way. A waste of time that would be necessary for installing a safety fence around the elevator docking zone and dismantling thereof for continuing the excavations is thus avoided. However, this fence is required when the excavation works are finished and the workers are constantly moving on the excavation ground.

In this embodiment of the docking method, the excavation ground has a definitive depth and a fence is installed around the docking perimeter of the cabin, with a secure access gate for accessing said elevator, and in which method the substep of emergency stopping of the cabin is deactivated and/or in which the plunger and the object detector are dismantled from the cabin.

Finally, the disclosure proposes a method for dismantling the elevator assembly of the disclosure, said elevator assembly including a load transfer system including at least one foot adjustable for height, said method including the following steps:
assembling said load transfer system on a bottom face of the tower while assembling said foot adjustable for height with a structure of the tower;
increasing a height of the adjustable feet until the weight of a primary anchoring part on which said tower is suspended is discharged, and obtaining a transfer of load to said adjustable feet in abutment on the ground;
dismantling the mast sections from top to bottom.

Other aims, advantages and particular features of the present disclosure will emerge from the following description, made for explanatory and in no way limitative purposes, with regard to the accompanying drawings.

### BRIEF DESCRIPTION OF THE DRAWINGS

FIG. 1 A schematic representation of the elevator assembly and of the fishplating of a mast section by the inverse assembly method.

FIG. 2 An embodiment of the suspension ramp of the elevator assembly. ON THE LEFT: a side view of the suspension ramp; ON THE RIGHT: a close-up view in perspective of a front face of a standard mast section.

FIG. 3 A perspective view of a rear face of the cabin according to one embodiment.

FIG. 4 A representation of the anti-collision system of the elevator assembly. ON THE LEFT: a side view of the cabin including an anti-collision system. ON THE RIGHT: a view of a front face of the cabin incorporating the anti-collision system.

FIG. 5 An embodiment of the load transfer system of the tower. ON THE LEFT: a view of a rear face of the tower incorporating the load transfer system. ON THE RIGHT: a side view of the tower incorporating the load transfer system.

### DETAILED DESCRIPTION

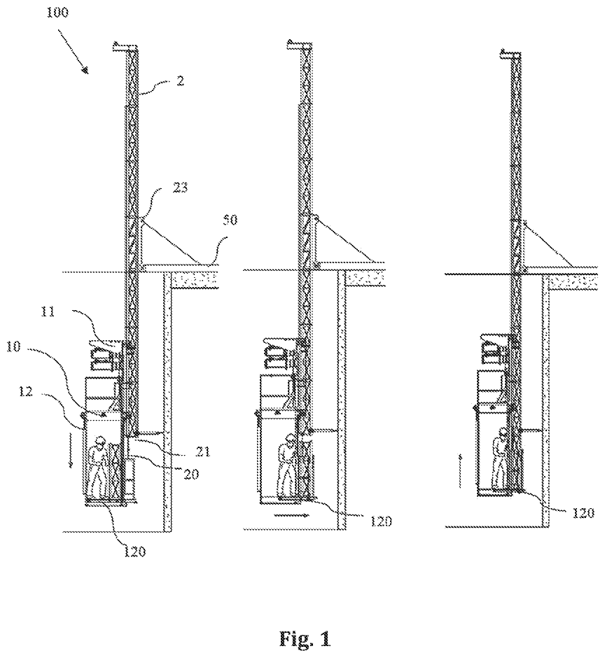

The present disclosure proposes an elevator assembly (FIG. 1) with a pinion/rack drive including a tower 2 and a cabin 10. The elevator assembly 100 is designed to allow the inverse assembly of the tower on a shaft/or gallery in the course of excavation. As illustrated in FIG. 1, the elevator assembly descends along a suspended tower as far as a bottom end 21 of said tower to convey mast sections to be assembled below the tower. Advantageously, the mast sections to be assembled are positioned for assembly thereof, one by one, by means of a movable deck 120 of said elevator.

The elevator assembly of the disclosure is highly advantageous in that it allows the inverse mounting of the tower autonomously and without having recourse to external means such as cranes or nacelles. This autonomous assembly is possible after the installation of a first subassembly including the cabin 10 mounted on a first tower part suspended at the top of the structure.

In one embodiment, said first tower part is a suspension ramp facilitating this installation step.

The Suspension Ramp

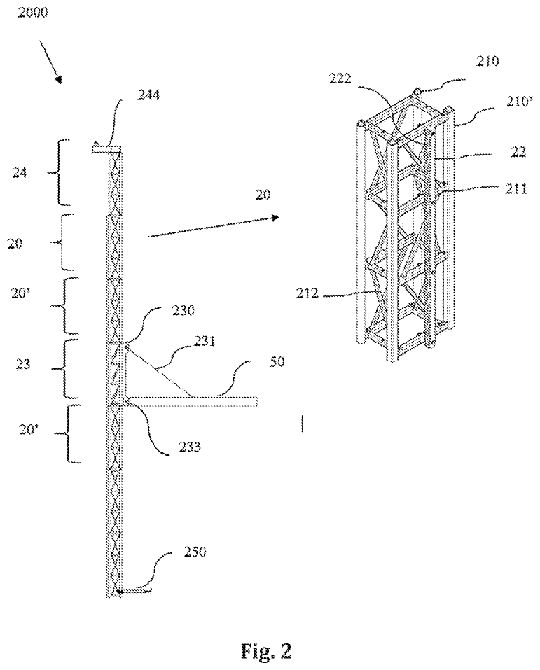

The suspension ramp 2000 (FIG. 2) is formed by a plurality of preassembled mast sections, in particular:
a head mast section 24 disposed at a top end of the tower and being secured to a lifting beam 244;
a suspension mast 23 including a connecting piece 230;
standard mast sections 20, 20′, provided where applicable with secondary stability anchoring parts 250.

In a non-limitative embodiment illustrated in FIG. 2, the mast sections of a tower structure include at least four angle posts 210, 210′ corresponding to the main members of a lattice beam connected to each other by four rigid horizontal frames 211 and braced by solid diagonals 212. In one embodiment, all the mast sections have the same dimensions, such as length 450 mm×width 250 mm×height 1508 mm, diameter 60. In another embodiment, the mast sections have different heights. The suspension mast section 23 is particular in that it is able to cooperate with said connecting piece and includes a structure able to absorb the forces generated by the suspension of the tower.

Each standard mast section 20, as well as the suspension mast section 23, includes a vertical rack section 22 secured to the horizontal frames 211 on a front face of the tower. The rack 22 includes a toothed lateral face 222 opposite to a smooth lateral face. The front face of the tower is referenced when the tower is installed in a structure, said front face being opposed to a wall of the structure and corresponding to the most remote face of said wall. The rear face of the tower is disposed face to face with the wall of the structure and corresponds to the face closest to the wall of the structure. The same references are used for describing the elevator.

Advantageously the head mast section 24 does not include a rack in order to avoid the cabin being driven in its highest section, and therefore preventing the risk of the cabin emerging upwards.

The suspension mast section 23 also includes the connecting part 230 by means of which the suspension ramp 2000 is suspended. In one embodiment, the connecting part 230 is produced in the form of two plates secured to a rear face of the suspension mast section and including top and bottom connecting (securing) points 233 for obtaining an embedding connection (or complete connection) with a primary anchoring part 50, itself in embedding connection with the structure. In the embodiment illustrated, the connecting points 233 are shafts. The primary anchoring part 50 is a beam secured to the edge slab of the well, at the top part of the structure, and includes notches for receiving the bottom shaft of the connecting part 230. A plate can be used for blocking the emergence of said shafts. A tie rod 231 or strut connects the top shaft to the primary anchoring part 50. In another embodiment, not illustrated, the primary anchoring part is secured to a wall of the wall.

The suspension ramp is lifted using a lifting beam 244 by means for example of a crane for conveying the ramp towards the anchoring part. The suspension ramp and the cabin installed on said ramp are thus suspended and secured at the top part of the structure. The tower is said to be suspended.

In order to stabilize the tower 2, secondary anchoring parts 250 are regularly secured on one side to the tower and on the other side to the wall of the structure. These secondary anchoring parts are installed for example every four mast sections 20 on the two rear angle posts 210 of the tower. In one embodiment, a secondary anchoring part 250 includes an anchoring tube secured by means of a securing collar to a rear angle post of the tower and having a securing lug intended to be secured to the wall of the structure.

After this first installation of the first subassembly including the suspension ramp 2000 and the cabin 10, the tower can be assembled autonomously by an operator towards the bottom of the excavation by means of the cabin and without having recourse to external means. This so-called inverse assembly is possible because of the features of the cabin of the disclosure.

The Cabin

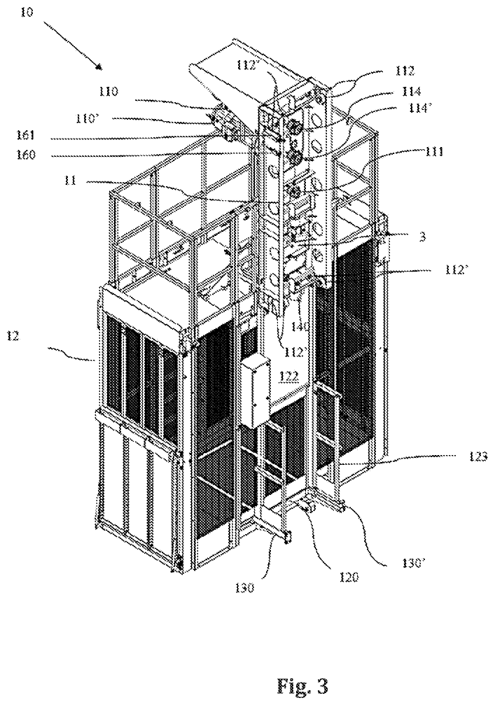

In particular, the cabin 10 includes a top part and a bottom part (FIG. 3). The top part corresponds to a drive unit 11 incorporating a pinion drive system engaging with the rack 22 of the tower, elements for guiding with the tower and a secure stop system for the cabin.

The bottom part corresponds to a cage 12 including a movable deck 120, sized to receive a mast section in the vertical position and designed to position said mast section below the tower when said deck is in an extended position.

The bottom part of the cabin is secured to the top part. Advantageously, the disclosure suggests suspending the cabin 10 from the tower 2 solely by means of the top part of the cabin, to enable the bottom part of the cabin to descend below a bottom end 21 of the suspended tower. More particularly, the cage 12 is suspended from the tower by means of the drive unit 11.

FIG. 3 shows an embodiment of the drive unit 11 provided with a chassis furthermore including:
said pinion drive system including a pair of motors 110, 110′ each equipped with a pinion 114, 114′;
the guide elements corresponding to guide rollers 112 and 112′ positioned on the chassis for guiding the movement of the cabin along the tower. For example, top rollers including a set of three guide rollers on each lateral side (left and right) of the chassis, and bottom rollers also including a set of three guide rollers on each lateral side (left and right) of the chassis;
a secure stop system for the cabin including:
   a parachute device 111 intended to brake and stop the cabin in the event of overspeed, said parachute device including a pinion engaging with the rack;
   a device for detecting absence of a top and bottom mast including two sensors positioned one at the top end of the chassis and the other at the bottom end of the chassis. These sensors are configured for transmitting a stop signal when the bottom or top end of the tower is detected, this signal resulting for example in the stoppage of the drive motor and triggering of a brake;
   an automatic top stop device including two drive-unit position sensors 160 and 161 disposed at the top part of the drive unit 11, actuated by two distinct cams secured to the tower 2, at a predefined safety distance from the top end of the tower. When the cabin rises and a cam actuates the first “top stop” position sensor, the cabin is automatically stopped. In the event of failure of the first position sensor, the cabin continues its travel until the second cam actuates the second drive-unit “top off-travel stop” position sensor, the cabin then being stopped automatically;
   an automatic bottom stop device including two position sensors disposed at the bottom part of the drive unit, actuated by two distinct cams, with different lengths and sliding in the chassis of the drive unit. These cams are actuated by a bottom stop secured to the tower, at a predefined safety distance from the bottom end of the tower. When the cabin 10 descends and the first cam bears on the bottom stop, the first “bottom stop” position sensor is actuated and the cabin is automatically stopped. In the event of failure of the first “bottom stop” position sensor, the cabin continues its travel until the second cam actuates the second “bottom off-travel stop” position sensor, the cabin then being stopped automatically. It should be noted that this automatic bottom stop device is activated only when said bottom stop is present on the tower;
   damper stops 140, able to come into contact with the bottom mechanical stop placed at a predefined safety distance from the bottom end of the tower, for damping and preventing the cabin from descending too low, and preventing the cabin from emerging downwards from the tower and thus avoiding a fall of the cabin;
   an anti-fall device 3, placed on a bottom part of the drive unit and being configured for adopting a triggered configuration when a member of the anti-fall device quits the bottom end of the tower. When the anti-fall device is triggered, a member meshes with the rack and stops the cabin. Simultaneously, a sensor detects the triggering of the anti-fall device and transmits a stop signal, resulting for example in the stoppage of the drive motor and the triggering of a brake.

In particular, the anti-fall device acts as an ultimate safety device for limiting the travel of the cabin downwards and the emergence thereof from the tower, in particular when the bottom stop is absent. For example, during operations of inverse assembly of the mast requiring the absence of said bottom stop for positioning an additional mast section.

The anti-fall device is therefore a safety element for the method of inverse assembly of the tower, this anti-fall device preventing the fall of the elevator when the bottom stop is not present on the mast and:
the operator is clumsy in controlling the movement (not stopping before emerging from the tower),
the bottom mast-absence detection device is faulty,
the motor brake (or brakes) are faulty and the cabin slides downwards,
the descent speed does not reach overspeed and therefore does not trigger the parachute device,
the operator is clumsy during a manual emergency descent.

A detailed example of an anti-fall device adapted to its use with the present disclosure is given in the French patent application No. 1873852.

During the inverse assembly operations, in normal use, stoppage of the cabin is controlled by the operator, so as to position the floor of the cage of the cabin below the tower, by a sufficient distance (H+100 mm) for incrementing a mast section. The mast section to be assembled is positioned on the movable deck 120 making it possible to place said section vertically in line with the tower already in place (see FIG. 1). For this purpose, the movable deck has at least two positions, a position retracted in the cabin and the position extended towards the rear of the cabin. The travel of the deck with respect to the cage is limited by at least one stop.

In a preferred embodiment, the deck 120 is a sliding deck and the cage of the cabin includes a pair of rails 130, 130′ extending horizontally from inside to outside, making it possible to guide the deck. Each rail includes a balustrade and stops. A width between the rails is greater than a width of the tower, so as to allow the movement of the tower between said rails.

In a retracted position of the deck 120 (as illustrated in FIG. 3), the deck is housed in the floor of the cage, with a top surface of the deck substantially level with the surface of said floor. The deck also includes a guillotine casing 122 determining a rear wall of the deck, said wall being complementary to a rear opening of the cage in which said casing is positioned when the deck is located in the retracted position. The casing 122 slides vertically along the balustrade. In the “in service” configuration of use, the deck is locked in the retracted position and the casing is locked in a position extended upwards, thus blocking any opening in the wall of the cage. In the “under assembly” configuration of use, the casing is released and slid into a retracted position (in front of the balustrade of the deck) enabling the operator to access the deck lock and to access the tower. The casing therefore moves with the deck. The deck and the casing are also provided with at least one locking means and at least one position sensor for making its use dependent on their position.

In order to position the mast section below the existing tower, the floor of the cabin is caused to descend to a height below the tower slightly greater than a height of the section of the mast to be assembled. The cabin is therefore driven electrically upwards at microspeed until the mast sections are in contact, so that an operator can fishplate said sections. For example, each mast section has a height H of 1508 mm and the cabin is configured so that the floor of the cage descends to −(H+100 mm), i.e. −1608 mm approximately below the tower. In one embodiment, the deck is provided with one or more centering devices making it possible to perfectly position the mast section on the deck, facilitating the contacting and fishplating with the tower. The deck 120 can also include an overload detection device implemented for example with one or more strain gauges transmitting a stop signal, in order to avoid damaging the movable deck, particularly when the mast section is put in contact with the tower. This is because, without such a device, the stopping is controlled by the operator. In the event of clumsiness the deck may be damaged.

The Method of Inverse Assembly of the Tower

As already mentioned, before commencing the inverse assembly of the tower, a prior step is implemented, consisting of securing to (or suspending from) the structure the subassembly composed of the suspension ramp 2000 equipped with the cabin 10, using external means such as a crane or nacelle.

In order to suspend the suspension ramp, it is necessary first to install the primary part 50 for anchoring to the structure. The primary anchoring part is specifically designed for implantation, and it will therefore be adapted according to requirements and constraints of its implantation related to each site.

1^{st} step of installing the elevator assembly: securing the subassembly to the structure.
1.1—installing the primary part 50 for anchoring to the structure, using, if necessary, external means such as a crane and/or elevating nacelle.
1.2—securing the subassembly to the primary anchoring part 50. The subassembly being composed of the suspension ramp equipped with the cabin. Step implemented using an external means such as crane.
1.3—securing the secondary anchoring parts 250.
1.4—electrically connecting the elevator assembly.

At the end of this first step, it is desirable to install a landing door for safe access to the elevator at the height of the structure;

2^{nd} step of installing the elevator assembly: inverse assembly of the tower.

As from this 2^{nd} step, the operator (fitter) is autonomous for implementing the inverse assembly of the tower by means of the elevator assembly of the disclosure. This second step includes the following substeps:
2.1—loading the n standard mast sections 20 and a pair of secondary stability anchoring parts 250 in the cabin;
2.2—descent of the cabin 10 in order to position the floor of the cabin at a distance slightly greater than the height H of the mast section. For example, a distance of at least H+50 mm, and preferably approximately H+100 mm;
2.3—positioning of a standard mast section 20 on the sliding deck in the vertical position and release of the deck to slide it towards the rear of the tower until it is in abutment. Preferably, this step of guiding and centering the tower is improved by installing at least two bolts, without nuts, diagonally on the last mast of the suspended tower.
2.4—Raising the cabin at microspeed unit contact between the mast section to be assembled and the suspended tower.
2.5—Fishplating the standard mast section with the last mast section of the suspended tower. For example, the fishplating is implemented by means of four M20×180 TH screws, eight M20 flat washers and four M20 locknuts.
2.6—Repeating substeps 2.2 to 2.5 to assemble the n remaining standard mast sections that have been loaded into the cabin.
2.7—Positioning the secondary anchoring parts 250 on the last mast section installed from the sliding deck in the extended position.
2.8—Raising the cabin to the top access level of the structure with the sliding deck in retracted and locked position.
2.9—Complete assembly of the tower by repeating substeps 2.2 to 2.9 until arriving at a required tower height.
2.10—Fitting a low stop on the tower. For example, a mechanical stop on the rack of the tower.

Docking the Elevator

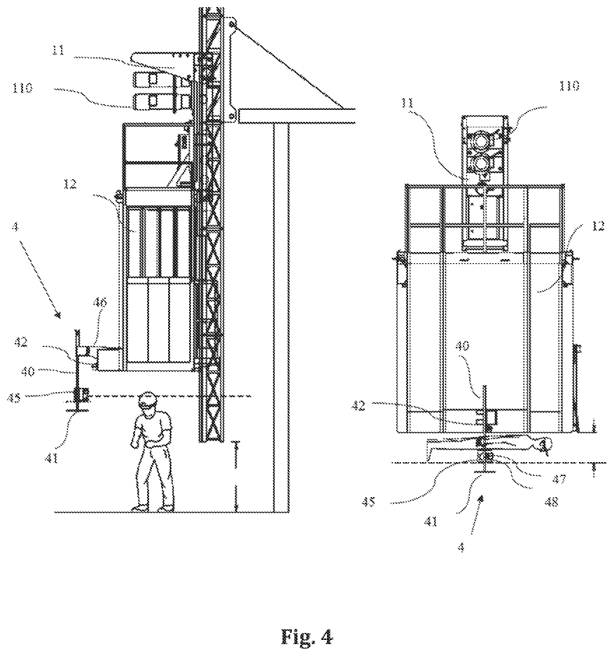

At the end of the second step the elevator assembly is ready for normal use thereof, i.e. to allow the transport of personnel and materials. Depending on the advancement of the digging works, the elevator assembly can be brought into service with a temporary tower height, and on a non-stabilized ground for which the digging works will continue subsequently. Advantageously, the present disclosure proposes equipping the elevator with an anti-collision system for preventing any risk of collision during docking of the elevator (FIG. 4).

The anti-collision system 4 makes it possible to determine a travel speed of the cabin, as well as controlling the automatic stopping of the cabin according to a distance of said cabin from the ground and/or the detection of an object in a docking zone of the cabin. For this purpose, the anti-collision system includes an object detector 45, a distance sensor 42, at least one position switch 47 and a plunger 40 extending from a bottom part of the cabin towards the ground and defining a minimum stop distance between the floor of said cabin and the ground of the excavation in contact with a foot 41 of said plunger.

The object detector is positioned below a bottom face of the cabin, for example on said plunger. As illustrated in the embodiment shown on the left in FIG. 4, the anti-collision system transmits an emergency stop signal when an object is detected by a detection beam along a horizontal plane of the object detector. Advantageously, the detection beam is positioned at a predefined distance X1 from the bottom face of the cage, and corresponding substantially to the distance X2 travelled by the cabin to obtain its complete stoppage following an emergency stop command at a programmed docking speed. For example, the direct detection beam is positioned at 370 mm from a bottom face of the cabin for a docking speed of 10 m/min.

In one embodiment, the object detector 45 is a laser scanner enabling objects to be detected below the elevator but also in a predefined radius, such as a radius of 8 m around the elevator.

Preferably, the anti-collision system is also provided with a camera for displaying images of the elevator docking zone.

According to one embodiment, the plunger 40 has a telescopic tubular body positioned vertically outside a front face of the cage 12 of the cabin 10, and is connected to said cage 12 of the cabin by means of a securing arm 46. Said plunger incorporates at least one first “bottom stop” position switch 47, preferably reinforced by a second “outside bottom travel” position switch 48. The first position switch 47 is activated when the plunger is put in contact with the ground and the body thereof is slightly pressed in, actuating said first position switch 47. The position switch 47 transmits a signal to an electric cubicle in the cabin, triggering an immediate command stopping the travel, if the cabin does not stop, the body of the plunger activates the second position switch 48 when it continues to sink in to control the ultimate stoppage of the travel.

In a non-limitative embodiment, the plunger has a height Y between the bottom face of the cabin and its foot on the ground of approximately 550 mm actuating the first switch, and a minimum height Ymin of approximately 420 mm actuating the second position switch and preventing the crushing of any person who might be lying underneath the cabin when a failure of the first switch and of the object detector does not stop the front cabin.

The anti-collision system 4 also makes it possible to determine the descent speed of the cabin when it approaches the ground of the excavation, this speed being able to be programmed according to the distance between the ground and the cabin detected by means of the distance sensor 42.

The cabin 10 is also provided with a foldable access ramp, with a non-slip floor, optionally controlled, lockable and maneuverable from the inside and the outside of the cabin when the elevator is at rest. Advantageously, a closed position of this ramp is controlled by a position sensor configured for enabling or preventing the movement of the cabin according to the position of the ramp. The cabin is accessed from a lateral side of the cabin by means of this access ramp.

Once the excavation works have arrived at a final depth, the elevator assembly will normally be used by personnel working at the bottom of the excavation. The flow of personnel around the docking area is fairly great and may therefore frequently cause the triggering of the anti-collision device and stop the cabin when it is docking. In order to optimize the docking, the disclosure proposes to install a fence around the elevator assembly including protective panels approximately 2 m high, and allowing access to the cabin only from a secure gate. This fence (not shown) is for example placed on the ground or is secured to the tower and not resting on the ground. The cabin docking zone is thus protected and the anti-collision device can be reconfigured so as no longer to demand the stoppage of the cabin when the object detector detects personnel or objects in the docking area. A descent speed can also be reprogrammed and the plunger of the anti-collision system dismantled.

Dismantling of the Elevator Assembly

A suspended elevator assembly, such as the elevator assembly of the disclosure, is normally dismantled from bottom upwards and autonomously by means of the cabin with the exception of the first part of the tower and of the cabin being dismantled by means of a crane or other lifting means. In the present disclosure, this autonomous dismantling method from bottom upwards is substantially equivalent to the reversed steps of the inverse assembly method.

In order to improve the dismantling time of the suspended elevator assembly, the disclosure proposes a load transfer system with which the weight of the assembly is transferred onto the ground to enable the tower to be dismantled from top downwards. Following the transfer of the load of the elevator assembly onto the ground, rapid dismantling from top downwards is implemented using a crane or other lifting means, as well as the cabin.

More particularly, the cabin is used to enable one or more operators to position themselves at a required height of the tower to attach the parts of the tower to the crane from a roof of the cage, as well as dismantling the fishplating and the anchoring of the tower from inside the cage.

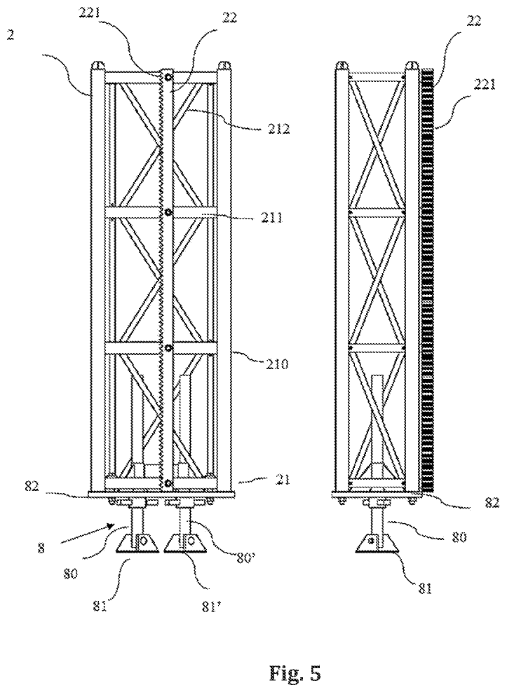

For this purpose, the elevator assembly includes a load transfer system including at least one foot adjustable for height, assembled at the bottom end of the tower. In the embodiment illustrated in FIG. 5, the transfer system includes two feet 80, 80′ adjustable for height and assembled at a bottom face of the tower by means of a securing plate 82. In another embodiment, the at least one foot is assembled directly at the bottom end of the tower and without the intermediary of a securing plate.

Advantageously, the feet 80 adjustable for height make it possible to configure the feet with a first height enabling the tower to bear on the ground, in order then to raise said tower during configuration thereof to a second height making it possible to unload the primary anchoring part and to transfer the weight of the tower onto the ground.

In the embodiment illustrated in FIG. 5, the plate 82 is fishplated in a horizontal position with the angle posts 210 of the tower, at least partially closing a bottom face of the tower. The adjustable feet form vertical jacks, bearing on the ground and extending upwards while passing through the plate, so that its top end is housed in the tower. The height of the adjustable feet is modified by means of a manual screw-and-nut jack system.

In another embodiment, the load transfer system is incorporated in the base fence.

The use of the elevator assembly is highly advantageous in excavation activities. This is because, because of the features of the elevator assembly of the disclosure, it will be possible to:
facilitate the installation of the elevator assembly by means of the suspension ramp;
implement autonomous inverse assembly of the tower by means of the cabin and movable deck;
protect and optimize the docking of the elevator during and after the excavation works, and
facilitate the dismantling of the elevator assembly by means of the load transfer system.

The present disclosure thus makes it possible to reduce the number of operators and means necessary for assembling and dismantling the elevator assembly, as well as improving the speed of these operations. The elevator assembly also makes it possible to protect sensitive operations, such as the step of inverse assembly by means of the secure stop system or the docking by means of the anti-collision system.

What is claimed is:

1. An elevator assembly with rack and pinion drive for excavation activities, said assembly including a tower provided with a rack and being assembled from a plurality of mast sections, a cabin including an electric cubicle and a center for controlling said cabin, characterized in that the cabin includes:
a top part including a drive unit wherein at least one pinion drive system cooperating with said rack, elements for guidance with the tower and a system for secure stoppage of the cabin are installed, and
a bottom part, secured to the top part and including a cage provided with a movable deck, said deck having an extended position for positioning a mast section to be assembled vertically in line with a bottom end of the tower when it is already in place and suspended from a structure, and a position retracted in a floor of the cage.

2. The elevator assembly according to claim 1, wherein the cage includes at least one position sensor and a means for locking said deck.

3. The elevator assembly according to claim 1, wherein the secure stop system includes:
a parachute device able to brake and stop the pinion drive system with the rack in the case of overspeed;
a device for detecting absence of lower and/or upper mast configured for transmitting a stop signal for the cabin when it detects a bottom and/or top end of the tower;
a device for automatic top stoppage of the drive unit including at least one position sensor for the drive-unit activated by a top stop cam secured at a predetermined safety distance from a top end of the tower;
an automatic device for bottom stoppage of the drive unit including at least one position sensor for the drive unit activated by a bottom stop cam secured to a chassis of the drive unit; and
an anti-fall device including a locking member configured for engaging with the rack when said device reaches the bottom end of the rack;
damper stops cooperating where necessary with a bottom stop installed on a bottom part of the tower.

4. The elevator assembly according to claim 1, including a suspension ramp preassembled from a plurality of mast sections and including:
a head mast section including a lifting beam on a top end and not being provided with a rack;
a suspension mast section including a connecting part intended to cooperate with an anchoring part secured at the top part of the excavation for suspending said suspension ramp, and being provided with a rack section; and
standard mast sections including a rack section.

5. The elevator assembly according to claim 1, including an anti-collision system communicating with the electric cubicle and the control center of the cabin, said anti collision system including:
an object detector configured for transmitting an emergency stop signal when an object is detected in a docking zone of the cabin;
a distance sensor configured for transmitting a travel speed controlling signal according to a distance detected between the cabin and the ground; and
a plunger provided with at least one position switch for demanding stopping of the travel, said plunger extending from a bottom part of the cabin towards the ground and having a height Y defining a minimum stop distance between the floor of the cabin and the ground of the works, and for which the position switch is activated when a foot of said plunger contacts the ground.

6. The elevator assembly according to claim 5, wherein the object detector includes a detection beam on a horizontal plane, said beam being positioned at a predefined distance X1 from a bottom face of the cage, and corresponding substantially to a distance X2 travelled by the cabin to obtain its total stoppage following a stop command triggered when the cabin moves at a programmed docking speed.

7. The elevator assembly according to claim 1, including a load transfer system enabling the suspended tower to bear on the ground, said transfer system including at least one adjustable foot for height assembled with the bottom end of the tower, and for which an increase in height puts said at least one adjustable foot in contact with the ground, and transfers a weight of the elevator assembly from a point of suspension from the tower to the ground.

8. A method for the inverse assembly of a tower by means of an elevator assembly according to claim 1, said method including a step of inverse assembly of the tower by gradual fishplating of a plurality of standard mast sections (20) conveyed by means of the elevator, said step including the following substeps, repeated until a required length of tower is obtained:
lowering a cabin of the elevator along the tower previously installed and as far as a bottom end of said tower;
stoppage of a floor of the cabin at a level below the tower;
positioning a standard mast section on a movable deck of a cage of the cabin, an extended position of said deck making it possible to place said mast section vertically in line with the last mast section of the tower already in place;
raising the cabin until the mast sections are put in contact and fishplating said section; and
stabilizing the suspended tower by attaching secondary anchoring parts every n standard mast sections assembled.

9. The method for inverse assembly of a tower according to claim 8, including a prior step wherein, at the top part of the structure, a first subassembly is installed including said cabin mounted on a suspension ramp, in which step the suspension ramp is slung from a beam for lifting said ramp, and suspended by a part for connecting said ramp to a first anchoring part secured to said top part of the structure.

10. The method for docking an elevator assembly according to claim 1, wherein the elevator assembly includes an anti collision system, including a plunger provided with a travel-stop position switch, an object detector and a distance sensor, said method including the following steps:
lowering the cabin at a first predefined travel speed and concomitantly measuring the distance between the cabin of the elevator and the ground by means of said distance sensor;
detecting a minimum distance threshold between the cabin and the ground by the distance sensor, and preferably stopping the travel of the cabin and activating an audible warning;
stopping the cabin when a minimum distance threshold between the cabin and the ground is signaled by the distance sensor, and preferably activating an audible warning;
lowering the cabin at a second reduced speed from the detection of said minimum distance threshold and during which the object detector monitors a zone for docking of the elevator on the ground and the surroundings thereof; and
stopping the cabin when an obstacle is detected by the object detector in said docking zone monitored or when the plunger touches the ground.

11. The method for docking an elevator assembly according to claim 10, wherein the excavation ground has a definitive depth and a fence is installed around the docking perimeter of the cabin (10), with a secure access gate for accessing the elevator, and in which method the substep of emergency stopping of the cabin (10) is deactivated and/or in which the plunger and the object detector are dismantled from the cabin.

12. The method for dismantling an elevator assembly according to claim 1, the elevator assembly including a load transfer system including at least one adjustable foot for height, said method including the following steps:
assembling the load transfer system on a bottom face of the tower while assembling said at least one adjustable foot for height with a structure of the tower;
increasing a height of the at least one adjustable foot until the weight of a primary anchoring part on which said tower is suspended is discharged, and obtaining a transfer of load to said at least one adjustable foot in abutment on the ground; and
dismantling the mast sections from top to bottom.
